(19) United States
(12) Patent Application Publication
(10) Pub. No.: US 2019/0137329 A1
(43) Pub. Date: May 9, 2019

(54) Vibration Sensor

(71) Applicant: VEGA GRIESHABER KG, Wolfach (DE)

(72) Inventors: Dominik Fehrenbach, Haslach (DE); Volker Allgaier, Haslach (DE); Holger Gruhler, Tuningen (DE); Gerd Ohmayer, Haslach (DE)

(21) Appl. No.: 16/039,841

(22) Filed: Jul. 19, 2018

(30) Foreign Application Priority Data
Aug. 28, 2017 (DE) 10 2017 119 714.1

(51) Int. Cl. G01H 11/02

(52) U.S. Cl. CPC G01H 11/02

(57) ABSTRACT

A vibration sensor with a diaphragm that can be excited to a vibration and a drive for setting the diaphragm into vibration and/or for detecting a vibration of the diaphragm, with the drive representing an electromagnetically acting drive and comprising at least one bolt coupled to the diaphragm, a permanent magnet, and a coil, with the drive showing a damper element which is embodied and arranged such that it damps interfering modes to a greater extent than effective modes.

### CROSS REFERENCE TO RELATED APPLICATIONS

This patent application claims priority to German Patent Application 102017119714.1, filed on Aug. 28, 2017.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a vibration sensor.

### Background of the Invention

Vibration sensors are known from prior art which are used for example as vibration limit switches, with the vibration sensor comprising a diaphragm that can be excited via a drive to vibrate, by which a mechanic transducer, arranged at the diaphragm, can be excited to vibrate. Depending on the coverage status of the mechanic transducer by a filled-in material and depending on the viscosity of said filled-in material the mechanic transducer vibrates with a characteristic frequency, which is detected by the vibration sensor and can be converted into a measuring signal.

From prior art both Piezo-electric as well as electromagnetic drives are known for such vibration sensors, with in the present case it being assumed that a vibration sensor is used with an electromagnetic drive.

FIGS. 3 and 4 show a drive of prior art.

FIG. 3 illustrates an electromagnetically driven vibration sensor 1 known from prior art, which can be used particularly as a vibration limit switch. The vibration sensor 1 comprises a diaphragm 3 which can be excited via a drive 5 to vibrate, while the drive 5 is formed by an electrifiable coil 9, supported at a housing 19 of the sensor 1, a coil core 21 arranged in the coil 9, as well as a bolt 7 arranged at the diaphragm 3. In the present drive 5 shown, the bolt 7 is connected via a so-called magnetic cup 8, which is in a threaded connection to the permanent magnet 10 such that the permanent magnet 10 is coupled fixed to the diaphragm. The permanent magnet 10 is aligned in the axial direction A and the extension of the bolt 7 and is magnetized. Any current applied to the coil 9 induces a magnetic field therein, which depending on its orientation attracts or repels the permanent magnet 7 arranged at the diaphragm 3, moving the diaphragm 3 in the respective direction. This way an electric signal can be converted into a movement of the diaphragm 3.

Similarly, a movement of the bolt 7 induces via the permanent magnet 10 a current flowing in the coil 9 such that movements of the diaphragm 3 can be converted into electric signals and thus can be detected.

On a side of the diaphragm 3 facing away from the drive 5 typically two mechanic transducers 17 are arranged, embodied as paddles, which transmit the oscillation coupled to the diaphragm 3 to a medium surrounding the mechanic transducers 17.

Vibration sensors of the above-described type, particularly vibration limit switches for liquids and bulk goods, operate based on the principle of resonance frequency shift. The vibration limit switch oscillates however depending on the coverage status, density, viscosity, and temperature of the medium with a different resonance frequency and amplitude. The amplitude of the resonance frequency is here a factor of the viscosity of the medium. The frequency shift depends on the density and temperature of the medium.

It is considered disadvantageous in drives known from prior art that mechanic influences upon the mechanic transducers as well as external vibrations and oscillations may lead to the bolt changing its position. Since this change in position, as shown in FIG. 3, generally represents a tilting of the permanent magnet in reference to the axial direction A and thus to the coil, here electric signals may be induced in the coil which cannot be distinguished from the actual measuring signal or at least interfere them in a disturbing fashion.

The objective of the present invention is to further improve a vibration sensor with an electromagnetic drive such that faulty detections based on mechanic influences upon the diaphragm and/or the mechanic transducer can be avoided.

This objective is attained in a vibration sensor and advantageous variants as taught and claimed herein.

### BRIEF SUMMARY OF THE INVENTION

In a preferred embodiment, a vibration sensor (1) with a diaphragm (3) that can be excited to vibrate, and a drive (5) for setting the diaphragm (3) into vibrations and/or for detecting a vibration of the diaphragm (3), with the drive (5) being an electromagnetic acting drive (5) and comprising at least one bolt (7) coupled to the diaphragm (3), a permanent magnet (10), and a coil (9), characterized in that the drive (5) comprises a damper element (11) which is embodied and arranged such that it damps interfering modes to a stronger extent than any effective modes.

In another preferred embodiment, a vibration sensor (1) as described herein, characterized in that the damping element (11) damps the interfering modes by at least a factor of 3, preferably at least 5, further preferred at least 20 times stronger than the effective modes.

In another preferred embodiment, a vibration sensor (1) as described herein, characterized in that the damper element (11) reduces an amplitude of the interfering modes by at least 90%, preferably at least 95%, and an amplitude of the effective mode by no more than 5%, preferably no more than 3%.

In another preferred embodiment, a vibration sensor (1) as described herein, characterized in that the damping element (11) is embodied as a damping spring.

In another preferred embodiment, a vibration sensor (1) as described herein, characterized in that the damping spring (11) is embodied as a diaphragm spring.

In another preferred embodiment, a vibration sensor (1) as described herein, characterized in that the diaphragm spring (11) shows a thickness from 0.1 mm to 1.0 mm.

7. A vibration sensor (1) according to any of claim 5 or 6, characterized in that the diaphragm spring (11) shows an inner ring (12), by which it can be connected directly or indirectly to the bolt (7), a magnetic holder (8), or the permanent magnet (10).

In another preferred embodiment, a vibration sensor (1) as described herein, characterized in that the diaphragm spring (11) comprises an outer ring (13), by which it can be connected to an element, fixed in reference to the diaphragm (3), preferably a housing (19), or a coil base on the other side.

In another preferred embodiment, a vibration sensor (1) as described herein, characterized in that a plurality of spring arms (21, 22) is arranged at the inner ring (12).

In another preferred embodiment, a vibration sensor (1) as described herein, characterized in that the spring arms (21, 22) extend from the inner ring (12) to the outer ring (13).

In another preferred embodiment, a vibration sensor (1) as described herein, characterized in that the spring arms (21, 22) extend radially, spirally, or meander-like.

In another preferred embodiment, a vibration sensor (1) as described herein, characterized in that four spring arms (21, 22) are arranged at the inner ring (12) at a right angle in reference to each other, with respectively two spring arms (21, 22) arranged opposite each other showing identical dimensions.

In another preferred embodiment, a vibration sensor (1) as described herein, characterized in that two first spring arms (21), extending in the direction of a connecting line (V) of two mechanic vibration elements (17), arranged at the diaphragm (3) at the side opposite the drive (5), are embodied wider than the two second spring arms (22) extending perpendicular in reference thereto.

In another preferred embodiment, a vibration sensor (1) as described herein, characterized in that the first spring arms (21) show a first width (b1) of 6 mm and the second spring arms (22) show a second width (b2) of 4 mm, and a length (L) preferably from 3 to 5 mm, preferably measuring 3.9 mm.

In another preferred embodiment, a vibration sensor (1) as described herein, characterized in that the damping element (11) is welded to the housing (19), preferably in a circumferential fashion.

In another preferred embodiment, a vibration sensor (1) as described herein, characterized in that two mechanic vibration elements (17), preferably paddles, are arranged at the diaphragm (3) at a side opposite the drive (5).

### BRIEF DESCRIPTION OF THE DRAWINGS

FIG. 1 is a line drawing evidencing a vibration sensor according to the present invention.

FIG. 2 is a line drawing evidencing a plan view from the top upon a cross-section through the vibration sensor of FIG. 1, slightly above the damping diaphragm.

FIG. 3 is a line drawing evidencing a vibration sensor according to prior art.

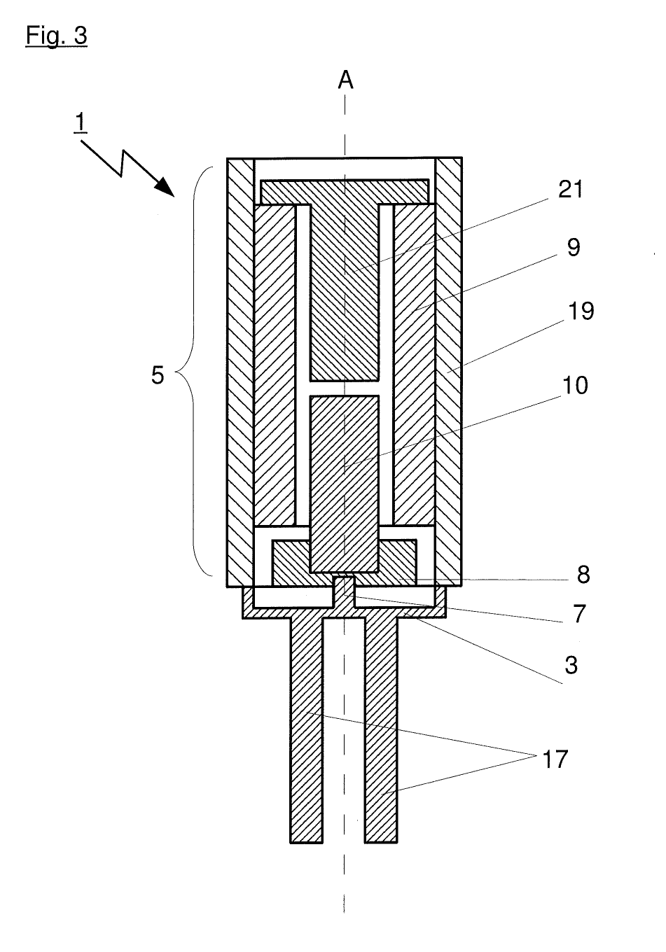

FIG. 4 is a line drawing evidencing the vibration sensor of FIG. 3 at an external impact of force upon the mechanic vibration elements.

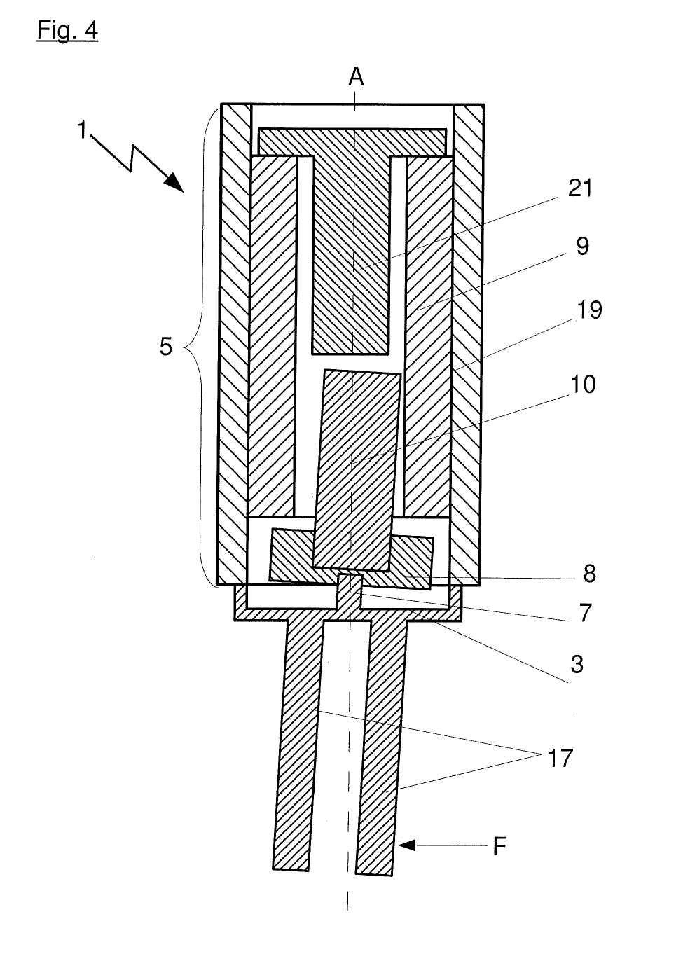

### DETAILED DESCRIPTION OF THE INVENTION

A vibration sensor according to the invention comprising a diaphragm that can be excited to vibrate and a drive for rendering the diaphragm to vibrate and/or for detecting a vibration of the diaphragm, in which the drive represents an electromagnetically operating drive and comprises at least one bolt coupled to the diaphragm, a permanent magnet, and a coil, is characterized in that the drive comprises a damper which is embodied and arranged such that it damps a disturbing mode to a greater extent than an effective mode.

The underlying vibration sensors essentially require for the drive and the detection a vibration mode, the so-called effective mode. The effective mode is here equivalent to the default mode of the diaphragm, which means the oscillation triggered by the movement of the bolt perpendicular to the diaphragm level.

Here, all oscillation modes are considered interfering modes, which trigger a faulty detection of the vibration sensor, thus particularly all modes which detect any movement of the bolt not aligned perpendicular to the level of the diaphragm.

Sufficiently high amplitudes for the effective mode can be yielded particularly when the damper damps the interfering modes to a greater extent than the effective mode by at least a factor of three, further preferred at least a factor of five, more preferred at least a factor of twenty. In a preferred embodiment the damper is embodied and arranged such that it reduces the amplitude of the interfering mode by at least 90%, preferably at least 95%, and an amplitude of the effective mode by no more than 5%, preferably by no more than 3%. This embodiment is based on the acknowledgment that it is advantageous for the effective mode to be suppressed as little as possible, which means particularly for a measurement that it is almost unnoticed and the interfering modes are suppressed almost entirely.

This can be achieved for example such that the damper is embodied as a damping spring. A particularly beneficial embodiment of the damping spring is a diaphragm spring, since it very well allows movements perpendicular to the level of the diaphragm and very well damps any motions parallel to the diaphragm level. If such a diaphragm spring is now used parallel to the diaphragm of the vibration sensor, here the effective mode can act perpendicular to the level of the diaphragm spring and therefore it is hardly damped at all, while the interfering modes all show high movement portions that are parallel to the level of the diaphragm spring and thus they are suppressed to a very large extent.

It has shown that in vibration sensors of prior art and diaphragm springs made from spring steel, particularly spring steel 1.4310, stainless steel, particularly stainless steel 1.4301, or steel, particularly steel C22, diaphragm springs are possible with a thickness from 0.1 mm to 1.0 mm as well as an exterior diameter from 20 mm to 50 mm, which allow good results. Particularly good results are yielded with planar diaphragms showing a thickness of 0.2 mm and partially perforated diaphragms with a thickness of 0.4 mm.

Preferably the diaphragm spring comprises an inner ring, by which it can be connected directly or indirectly to the bolt, a magnetic fastener, or a permanent magnet. The diaphragm spring can this way easily be connected to one of the an oscillating components, for example the permanent magnet or the magnet holder in which the permanent magnet is arranged, so that sufficient distance is yielded for the diaphragm spring from the diaphragm of the vibration sensor. Due to the fact that the diaphragm spring is arranged at a distance from the diaphragm, here an improved damping behavior is achieved since the interfering modes, due to the fastening of the bolt, magnetic fastener, and the permanent magnet at the diaphragm, show an axis of rotation in the diaphragm level and thus they can be very well compensated at a certain distance from the diaphragm.

In order to further improve the damping effect of the diaphragm spring it may show an outer ring by which it can be connected to an element fixed in reference to the diaphragm, preferably a housing or a coil base. For example the outer ring can be welded to the housing of the vibration sensor or clamped between a stop of the housing and a threaded sheath. This way fixation of the diaphragm spring is yielded both in the axial as well as the radial direction, allowing an even better adjustment of the damping effect.

In addition to the use of a planar diaphragm spring the diaphragm spring may also be embodied in a partially perforated fashion. For this purpose a plurality of spring braces may be arranged at the inner ring, which extends at least sectionally in the radial direction. When embodying the diaphragm spring with such spring braces, here a damping characteristic of the diaphragm spring can be influenced. In particular, it is possible this way to equip the diaphragm spring such that it shows different damping effects in the various directions of the diaphragm level.

A particularly simple handling of diaphragm springs embodied with spring braces is yielded when the spring braces extend from the inner ring to the outer ring, since this way a defined external circumference of the diaphragm spring can be generated.

The spring braces may particularly extend radially, spirally, or meander-shaped.

In a particularly preferred embodiment four spring braces are arranged at a right angle in reference to each other, with respectively two spring braces arranged opposite each other showing identical dimensions. Such a symmetric embodiment is beneficial since vibration sensors of the underlying type are typically designed in a point-symmetrical fashion. Further, it is possible thereby to embody the diaphragm spring such that it can damp particularly well any interfering modes occurring in a preferred direction.

This may be achieved for example such that two first spring braces, extending in the direction of a connecting line of two mechanic oscillating elements, arranged at the diaphragm at a side opposite the drive, are embodied wider than the two second spring braces extending perpendicular thereto. Due to the fact that commonly paddles are used as mechanic oscillating elements, arranged parallel to each other, which are aligned perpendicular to the connecting line between their contact points at the diaphragm, here certain interfering modes occur preferably in the direction of the connecting lines of the fastening points of these mechanic transducers. In order to damp such interfering modes in a particularly effective fashion it is beneficial for the respective spring braces to be embodied stronger, particularly wider.

For example the first spring braces may show a width of 6 mm and the second spring braces may show a width of 4 mm, with the spring braces in typical vibration sensors showing usually a length from 3 mm to 5 mm, particularly from 3.5 mm to 4.5 mm, and further preferred measuring 3.9 mm.

Preferably the damping element is welded to the housing, allowing to yield a particularly stable fastening of the damping element by a circumferential welding seam.

The present invention can generally be used in vibration sensors with mechanic oscillation elements, with in one here preferred embodiment two mechanic vibration elements being arranged at a side of the diaphragm opposite the drive, showing the form of paddles arranged parallel in reference to each other.

In the present application the term effective mode represents the status in which in the default mode of the diaphragm the diaphragm follows the movement of the bolt, thus perpendicular to the diaphragm level.

All vibration modes are called interfering modes, which trigger a faulty detection of the vibration sensor, particularly all modes which include a motion of the bolt which is not perpendicular to the level of the diaphragm.

Largely undamped in the sense of the present invention means here that an amplitude of the respective vibration mode is reduced by the damper by no more than 5% compared to an undamped amplitude.

Maximally damped in the sense of the present invention represents here that an amplitude of the respective vibration mode is reduced by the damper by at least 90% in reference to an undamped amplitude.

In a preferred embodiment two mechanic transducers are arranged at the diaphragm, showing the form of rods or paddles. The diaphragm spring is equipped with an inner ring and an outer ring, with the inner ring and the outer ring being preferably coupled to each other with four radially extending spring braces. The diaphragm spring shows a thickness of 0.4 mm. The diaphragm spring is arranged in the housing aligned parallel in reference to the diaphragm and the mechanic transducers, this means that two first spring braces extend in the direction of a connecting line of the mechanic transducers in their point of connection, and the two remaining spring arms extend perpendicular thereto. The first spring braces show a width of 6 mm and the second spring braces show a width of 4 mm, all of that at a length of respectively 3.9 mm between the inner ring and the outer ring. The inner ring and the outer ring show respectively a radial extension of 1.0 mm, with the outer ring being circumferentially welded to the housing.

In the following the present invention is explained based on an exemplary embodiment with reference to the attached figures. Unless stipulated otherwise, identical reference characters mark identical elements.

### DETAILED DESCRIPTION OF THE FIGURES

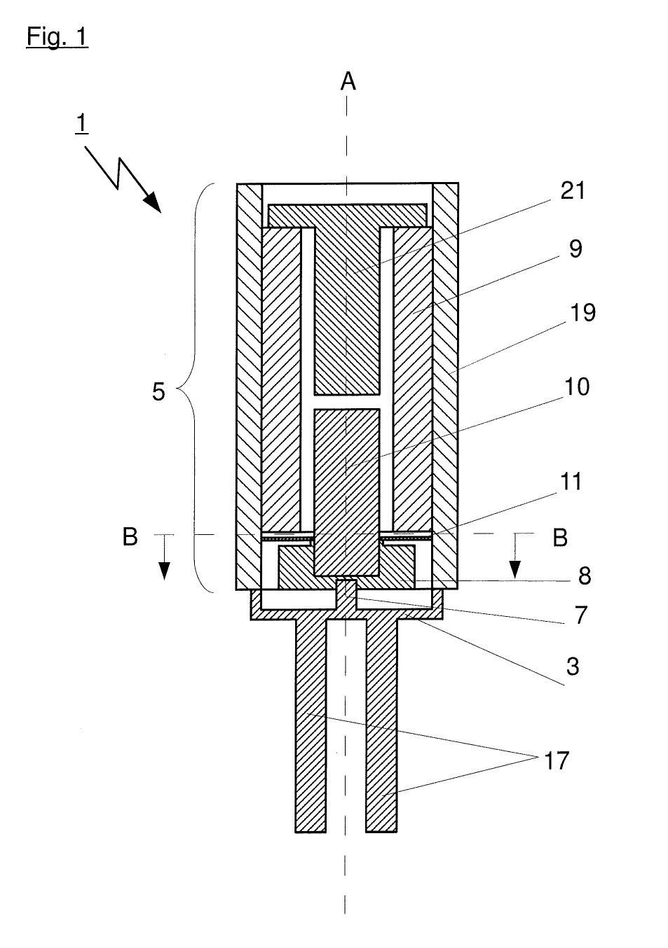

FIG. 1 shows a cross-section of a vibration sensor 1 according to the present invention. The vibration sensor 1 is shown only schematically in the illustration provided and not drawn true to scale.

The vibration sensor 1 comprises a diaphragm 3 that can be excited to oscillate via a drive 5, with the drive 5 being formed by a coil 9 that can be electrified and is supported at a housing 19 of the sensor 1, a coil core 21 arranged at the coil 9, as well as a bolt 7 arranged at the diaphragm 3. In the present drive 5 shown, the bolt 7 is connected via a so-called magnetic holder 8, screwed via the bolt 7 to the permanent magnet 10, so that the permanent magnet 10 is coupled fixed to the diaphragm. The permanent magnet 10 is aligned in the axial direction A and the extension of the bolt 7 and is magnetized. A current applied to the coil 9 induces in it a magnetic field, which then depending on its orientation attracts the permanent magnet 10 arranged at the diaphragm 3 or repels it, causing the diaphragm 3 to be moved in the respective direction. This way an electric signal can be converted into a movement of the diaphragm 3.

Similarly, a motion of the bolt 7 induces via the permanent magnet 10 a current in the coil 9 such that movements of the diaphragm 3 are converted into electric signals and this way can be detected.

At a side of the diaphragm 3 facing away from the drive 5 typically two mechanic transducers 17 are arranged, embodied as paddles, which transfer the vibration coupled into the diaphragm 3 upon a medium surrounding the mechanic vibration elements 17.

In the present exemplary embodiment a damping element 11 in the form of a diaphragm spring is arranged between the magnetic fastener 8 and the coil 9. The diaphragm 11 is fastened in the present exemplary embodiment at the inside at a projection of the magnetic fastener 8 and at the outside at the housing 19. At the outside, the diaphragm spring 11 is welded circumferentially to the housing 19 such that a fixation of the diaphragm spring 11 occurs in the axial direction A as well as the radial direction R, and particularly any tipping of the diaphragm spring 11 in reference to the housing 19 is prevented. The diaphragm spring 11 is embodied parallel in reference to the diaphragm 3.

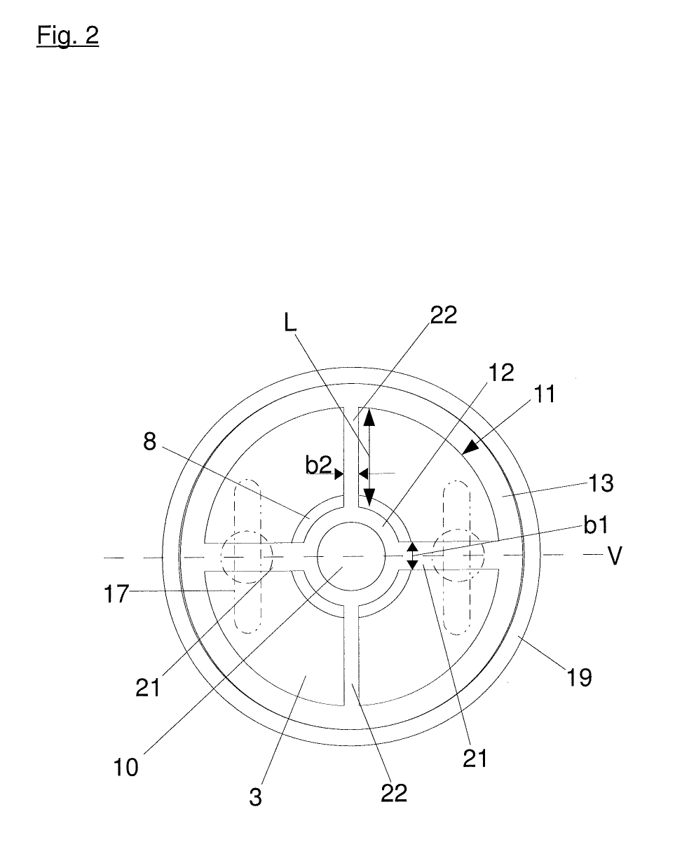

FIG. 2 shows a cross-section through a vibration sensor 1 of FIG. 1 along the line B-B drawn in FIG. 1 and in the direction of view of the arrows also drawn.

From the view shown in FIG. 2 it is discernible in a particularly clear fashion that the diaphragm spring 11 in the present exemplary embodiment is formed as a perforated diaphragm spring 11 with spring arms 21, 22 extending radially between the inner ring 12 and an outer ring 13. In the present exemplary embodiment the spring arms 21, 22 are arranged perpendicularly in reference to each other, with the first spring arms 21 extending along a connecting line V between the fastening sites of the mechanic transducers 17 at the diaphragm 3, are embodied with a greater first width b1 than the second spring arms 22, extending perpendicular thereto, which show a width b2. All spring arms 21, 22 show an identical length 1, in the present case 3.9 mm from an external radius of the inner ring 12 to an internal radius of the outer ring 13. The first width b1 of the first spring arms 21 amounts in the present exemplary embodiment to 6 mm, with the second width b2 of the second spring arms 22 in the present exemplary embodiment amounting to 4 mm. The diaphragm spring 11 shows in the present exemplary embodiment a thickness of 0.4 mm and is produced from spring steel 1.4310. At the perimeter the diaphragm spring 11 is welded circumferentially to the housing 19.

### LIST OF REFERENCE CHARACTERS

1 vibration sensor
3 diaphragm
5 drive
7 bolt
8 magnetic holder
9 coil
10 permanent magnet
11 diaphragm spring, damping element, damping spring
12 inner ring
13 outer ring
17 vibration elements, transducers
19 housing
21 first spring arm
22 second spring arm
A axial spring
b1 first width
b2 second width
L length

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A vibration sensor with a diaphragm that can be excited to vibrate, and a drive for setting the diaphragm into vibrations and/or for detecting a vibration of the diaphragm, with the drive being an electromagnetic acting drive and comprising at least one bolt coupled to the diaphragm, a permanent magnet, and a coil, characterized in that the drive comprises a damper element which is embodied and arranged such that it damps interfering modes to a stronger extent than any effective modes.

2. The vibration sensor according to claim 1, wherein the damping element damps the interfering modes by at least a factor of 3 times stronger than the effective modes.

3. A vibration sensor according to claim 1, wherein the damper element reduces an amplitude of the interfering modes by at least 90%, preferably at least 95%, and an amplitude of the effective mode by no more than 5%, preferably no more than 3%.

4. The vibration sensor according to claim 1, wherein the damping element is embodied as a damping spring.

5. The vibration sensor according to claim 4, wherein the damping spring is embodied as a diaphragm spring.

6. The vibration sensor according to claim 5, wherein the diaphragm spring has a thickness from 0.1 mm to 1.0 mm.

7. The vibration sensor according to claim 5, wherein the diaphragm spring shows an inner ring, by which it can be connected directly or indirectly to the bolt, a magnetic holder, or the permanent magnet.

8. The vibration sensor according to claims, wherein the diaphragm spring comprises an outer ring, by which it can be connected to an element, fixed in reference to the diaphragm, preferably a housing, or a coil base on the other side.

9. The vibration sensor according to claim 5, wherein a plurality of spring arms is arranged at the inner ring.

10. The vibration sensor according to claim 8, characterized in that the spring arms extend from the inner ring to the outer ring.

11. The vibration sensor according to claim 9, wherein the spring arms extend radially, spirally, or meander-like.

12. The vibration sensor according to claim 8, further comprising wherein four spring arms are arranged at the inner ring at a right angle in reference to each other, with respectively two spring arms arranged opposite each other showing identical dimensions.

13. The vibration sensor according to claim 12, wherein the two first spring arms, extending in the direction of a connecting line of two mechanic vibration elements, arranged at the diaphragm at the side opposite the drive, are embodied wider than the two second spring arms extending perpendicular in reference thereto.

14. The vibration sensor according to claim 13, wherein the first spring arms show a first width of 6 mm and the second spring arms show a second width of 4 mm, and a length preferably from 3 to 5 mm, preferably measuring 3.9 mm.

15. The vibration sensor according to claim 1, wherein the damping element is welded to the housing preferably in a circumferential fashion.

16. The vibration sensor according to claim 1, further comprising wherein two mechanic vibration elements, embodied as paddles are arranged at the diaphragm at a side opposite the drive.
